(19) United States
(12) Patent Application Publication
(10) Pub. No.: US 2026/0169808 A1
(43) Pub. Date: Jun. 18, 2026

(54) COMPUTE RESOURCE ORCHESTRATION FRAMEWORK FOR BALANCING ARTIFICIAL INTELLIGENCE WORKLOADS AND NETWORK PERFORMANCE

(71) Applicant: QUALCOMM Incorporated, San Diego, CA (US)

(72) Inventors: Gaurao Onkar CHAUDHARI, San Jose, CA (US); Sandip HOMCHAUDHURI, San Jose, CA (US); Rajakumar Ebenezar DEVAIRAKKAM, Sunnyvale, CA (US); Vikram SINGH, San Diego, CA (US); Ganesh SWAMINATHAN, Fremont, CA (US); Rahul PATEL, San Jose, CA (US); Syam Krishna BABBELLAPATI, Fremont, CA (US)

(21) Appl. No.: 19/341,591

(22) Filed: Sep. 26, 2025

Related U.S. Application Data
(60) Provisional application No. 63/735,204, filed on Dec. 17, 2024.

(51) Int. Cl. G06F 9/50; H04W 28/08; H04W 72/56

(52) U.S. Cl. CPC G06F 9/5027; G06F 9/5083; H04W 28/08; H04W 72/56; G06F 2209/503

(57) ABSTRACT

This disclosure provides methods, components, devices and systems for compute resource orchestration framework for balancing artificial intelligence (AI) workloads and network performance. Some aspects more specifically relate to an operating system and an orchestration framework that assigns compute resources to a set of AI workloads of an access point (AP). In accordance with the operating system and orchestration framework, a network node may assign compute resources to the set of AI workloads in accordance with workload parameters of the set of AI workloads, a compute resource availability at the AP, and/or one or more criteria pertaining to a set of network parameters in a wireless network in which the AP operates. The network node may assign the compute resources to the set of AI workloads in a manner that satisfies the criteria pertaining to the set of network parameters.

### CROSS REFERENCES

The present Application for Patent claims benefit of U.S. Provisional Patent Application No. 63/735,204 by CHAUDHARI et al., entitled “COMPUTE RESOURCE ORCHESTRATION FRAMEWORK FOR BALANCING ARTIFICIAL INTELLIGENCE WORKLOADS AND NETWORK PERFORMANCE,” filed Dec. 17, 2024, assigned to the assignee hereof, and expressly incorporated herein.

### TECHNICAL FIELD

This disclosure relates generally to wireless communication and, more specifically, to compute resource orchestration framework for balancing artificial intelligence (AI) workloads and network performance.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

In some wireless communication networks, an AP may have multiple wired interfaces in addition to wireless interfaces. In such wireless communication networks, the AP may support (such as serve) a variety of connected clients in an access stratum using one or more wired transports in addition to supporting a variety of connected clients in the access stratum using one or more wireless transports. For example, the AP may provide connectivity to a local area network (LAN) and may route packets between a first end client and the network using a wired transport and between a second end client and the network using a wireless transport. The network may be enabled by one or more broadband technologies and the AP, which may be deployed to provide a last section of wireless connectivity to the LAN, may be understood as a broadband gateway, a gateway device, or a router. The AP may execute a set of workloads of such broadband technologies, which may be referred to as broadband or networking workloads. In some deployment scenarios, the AP may receive requests to execute other workloads in addition to networking workloads. Such other workloads may consume a large amount of compute resources at the AP and, in some scenarios, may starve out compute resources needed or expected by networking workloads.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a network node. The network node may include a processing system that includes processor circuitry and memory circuitry that stores code. The processing system may be configured to cause the network node to receive a set of multiple workload requests corresponding to a set of multiple artificial intelligence (AI) workloads of an access point (AP), the set of multiple AI workloads having a set of multiple sets of workload parameters, and each AI workload of the set of multiple AI workloads having a respective set of workload parameters of the set of multiple sets of workload parameters, and assign compute resources to the set of multiple AI workloads in accordance with the set of multiple sets of workload parameters of the set of multiple AI workloads; a compute resource availability at the AP; and one or more criteria pertaining to a set of network parameters, the set of network parameters including one or more of a packet rate, a quality of service (QoS) level, a packet delay, or an amount of buffered network traffic in a wireless network in which the AP operates.

Another innovative aspect of the subject matter described in this disclosure can be implemented in a method for compute resource orchestration by a network node. The method may include receiving a set of multiple workload requests corresponding to a set of multiple AI workloads of an AP, the set of multiple AI workloads having a set of multiple sets of workload parameters, and each AI workload of the set of multiple AI workloads having a respective set of workload parameters of the set of multiple sets of workload parameters, and assigning compute resources to the set of multiple AI workloads in accordance with the set of multiple sets of workload parameters of the set of multiple AI workloads; a compute resource availability at the AP; and one or more criteria pertaining to a set of network parameters, the set of network parameters including one or more of a packet rate, a QoS level, a packet delay, or an amount of buffered network traffic in a wireless network in which the AP operates.

Another innovative aspect of the subject matter described in this disclosure can be implemented in a network node. The network node may include means for receiving a set of multiple workload requests corresponding to a set of multiple AI workloads of an AP, the set of multiple AI workloads having a set of multiple sets of workload parameters, and each AI workload of the set of multiple AI workloads having a respective set of workload parameters of the set of multiple sets of workload parameters, and means for assigning compute resources to the set of multiple AI workloads in accordance with the set of multiple sets of workload parameters of the set of multiple AI workloads; a compute resource availability at the AP; and one or more criteria pertaining to a set of network parameters, the set of network parameters including one or more of a packet rate, a QoS level, a packet delay, or an amount of buffered network traffic in a wireless network in which the AP operates.

Another innovative aspect of the subject matter described in this disclosure can be implemented in a non-transitory computer-readable medium storing code for wireless communication by a network node. The code may include instructions executable by a processing system to receive a set of multiple workload requests corresponding to a set of multiple AI workloads of an AP, the set of multiple AI workloads having a set of multiple sets of workload parameters, and each AI workload of the set of multiple AI workloads having a respective set of workload parameters of the set of multiple sets of workload parameters, and assign compute resources to the set of multiple AI workloads in accordance with the set of multiple sets of workload parameters of the set of multiple AI workloads; a compute resource availability at the AP; and one or more criteria pertaining to a set of network parameters, the set of network parameters including one or more of a packet rate, a QoS level, a packet delay, or an amount of buffered network traffic in a wireless network in which the AP operates.

Some examples of the method, network nodes, and non-transitory computer-readable medium described herein may further include operations, features, means, or instructions for scheduling a time domain order of an execution of the set of multiple AI workloads in accordance with the set of multiple sets of workload parameters of the set of multiple AI workloads, with the compute resource availability at the AP, and with the one or more criteria pertaining to the set of network parameters.

In some examples of the method, network nodes, and non-transitory computer-readable medium described herein, scheduling the time domain order may include operations, features, means, or instructions for determining whether a dequeue counter of a workload queue satisfies a threshold, and sorting a set of multiple of dequeued workloads by execution time, where the time domain order is in accordance with sorting the set of multiple of dequeued workloads.

In some examples of the method, network nodes, and non-transitory computer-readable medium described herein, the time domain order of the execution of the set of multiple AI workloads may be in accordance with a set of multiple workload queues and the method, apparatuses, and non-transitory computer-readable medium may include further operations, features, means, or instructions for scheduling the set of multiple AI workloads in the set of multiple workload queues in accordance with a respective priority of each AI workload of the set of multiple AI workloads, and the AP being unable to simultaneously execute the set of multiple AI workloads in accordance with the compute resource availability at the AP or the one or more criteria pertaining to the set of network parameters.

In some examples of the method, network nodes, and non-transitory computer-readable medium described herein, assigning the compute resources to the set of multiple AI workloads may include operations, features, means, or instructions for determining whether a dequeue counter of a first queue of the set of multiple of workload queues satisfies a threshold, and executing a workload from a second queue of the set of multiple of workload queues in accordance with the dequeue counter satisfying the threshold, where the first queue comprises higher priority workloads than the second queue.

Some examples of the method, network nodes, and non-transitory computer-readable medium described herein may further include operations, features, means, or instructions for loading a set of multiple AI models to at least one memory in accordance with the time domain order of the execution of the set of multiple AI workloads. In some examples of the method, network nodes, and non-transitory computer-readable medium described herein, each AI workload of the set of multiple AI workloads may be executed using a respective AI model of the set of multiple AI models.

Some examples of the method, network nodes, and non-transitory computer-readable medium described herein may further include operations, features, means, or instructions for offloading one or more AI models of the set of multiple AI models from the at least one memory in accordance with one or more priorities of the one or more AI models being relatively lower than one or more other priorities of one or more other AI models of the set of multiple AI models.

In some examples of the method, network nodes, and non-transitory computer-readable medium described herein, assigning the compute resources to the set of multiple AI workloads may include operations, features, means, or instructions for assigning a first set of compute resources of the AP to one or more first AI workloads of the set of multiple AI workloads in accordance with the compute resource availability at the AP being able to execute the one or more first AI workloads and satisfy the one or more criteria pertaining to the set of network parameters and assigning a second set of compute resources of the network node or another node to one or more second AI workloads of the set of multiple AI workloads in accordance with the compute resource availability at the AP being unable to additionally execute the one or more second AI workloads and satisfy the one or more criteria pertaining to the set of network parameters.

Some examples of the method, network nodes, and non-transitory computer-readable medium described herein may further include operations, features, means, or instructions for assigning a first portion of a set of cache resources to a set of networking workloads of the AP to satisfy the one or more criteria pertaining to the set of network parameters and assigning a second portion of the set of cache resources to the set of multiple AI workloads in accordance with the set of multiple sets of workload parameters of the set of multiple AI workloads.

Some examples of the method, network nodes, and non-transitory computer-readable medium described herein may further include operations, features, means, or instructions for adjusting a threshold network parameter in accordance with receiving the set of multiple workload requests corresponding to the set of multiple AI workloads. In some examples of the method, network nodes, and non-transitory computer-readable medium described herein, the one or more criteria pertaining to the set of network parameters may include the threshold network parameter.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example artificial intelligence (AI) workload path that supports compute resource orchestration framework for balancing AI workloads and network performance.

FIG. 3 shows an example wireless communication network that supports compute resource orchestration framework for balancing AI workloads and network performance.

FIG. 4 shows an example AI gateway that supports compute resource orchestration framework for balancing AI workloads and network performance.

FIG. 5 shows an example AI workload path that supports compute resource orchestration framework for balancing AI workloads and network performance.

FIG. 6 shows an example operating system that supports compute resource orchestration framework for balancing AI workloads and network performance.

FIG. 7 shows an example cache allocation across AI and networking workloads that supports compute resource orchestration framework for balancing AI workloads and network performance.

FIGS. 8 and 9 show example workload scheduling procedures that support compute resource orchestration framework for balancing AI workloads and network performance.

FIG. 10 shows a block diagram of an example wireless communication device that supports compute resource orchestration framework for balancing AI workloads and network performance.

FIG. 11 shows a flowchart illustrating an example process performable by or at a network node that supports compute resource orchestration framework for balancing AI workloads and network performance.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, an access point (AP) may provide connectivity (such as Layer 2 (L2 ) connectivity) to a local area network (LAN) and may route packets between one or more end clients and the network. The AP may route packets between one or more first end clients and the network using wireless transports and, in some scenarios, may additionally route packets between one or more second end clients and the network using wired transports. The wired transports may include Ethernet, passive optical network (PON), and data over cable service interface specification (DOCSIS) transports, among other examples. The wireless transports may include cellular or Wi-Fi transports, among other examples. Such wired or wireless transports may be examples a networking technology, such as a broadband technology. In addition to providing L2 connectivity, some APs may support one or more application services. Further, some APs may provide, include, or support artificial intelligence (AI) compute capabilities, which an AP may use to provide a richer experience by terminating various packet flows in the AP and enabling support for various types of applications at the AP. For example, an AP may support an AI application and may use one or more compute resources of the AP to execute (such as process or perform) AI workloads of the AI application. By terminating packet flows for the AI workloads in the AP, the AP itself may execute the AI workloads and avoid incurring additional latency caused by providing the AI workloads to another node for execution. Compared to non-AI workloads, AI workloads may involve a relatively large quantity of mathematical computations in a relatively short amount of time. In accordance with such characteristics, AI workloads may consume a large amount of compute resources at the AP and, in some scenarios, may starve out compute resources needed or expected by other workloads at the AP (including, for example, networking workloads, such as workloads for communicating broadband traffic, which may include parsing received packets, generating packets for transmission, and/or performing or processing signal strength measurements) in an unpredictable manner. Such an unpredictable usage of compute resources at the AP may result in unpredictable workload execution timelines and unpredictable network performance, which may cause the AP to be unreliable in scenarios in which the AP concurrently supports AI and networking workloads.

Various aspects relate generally to a compute resource orchestration framework that balances AI workloads and network performance. Some aspects more specifically relate to an operating system and an orchestration framework that assigns compute resources to one or more AI workloads of an AP. In accordance with the operating system and orchestration framework, a network node (such as the AP or another network node) may assign compute resources to AI workloads of an AP in accordance with (such as by factoring in or otherwise accounting for) one or more parameters and/or criteria. Such parameters and/or criteria may include (but are not limited to) workload parameters (such as a priority, an inference latency constraint, a quantity of requested or predicted compute resources, and/or a requested type of processing unit) of the AI workloads, a compute resource availability (such as a memory load usage, a memory bandwidth usage, a processor utilization, and/or a thermal constraint) at the AP, and/or one or more criteria pertaining to a set of network parameters (such as one or more criteria pertaining to a packet rate, a quality of service (QoS) level, a packet delay, and/or an amount of buffered network traffic) in a wireless network in which the AP operates. In some examples, the network node may assign compute resources to the AI workloads such that the workload parameters of the AI workloads and the compute resource availability at the AP are accounted for and such that the criteria pertaining to the set of network parameters are satisfied. In some examples, the network node may schedule an execution order of the AI workloads. In such examples, the network node, using a workload scheduler of the operating system, may schedule the AI workloads in a set of workload queues, such as a higher priority workload queue and a lower priority workload queue. Additional aspects more specifically relate to AI model loading, virtualization of compute resources and/or the operating system across one or more nodes, and parameter adjustments such that the network node may control the criteria pertaining to the set of network parameters, among other aspects.

Particular aspects of the subject matter described in this disclosure can be implemented to realize one or more of the following potential advantages. In some examples, by assigning compute resources to an AI workload of an AP in accordance with the described operating system and orchestration framework, a network node may satisfy an expected execution timeline of the AI workload and satisfy a threshold network performance. In other words, the network node may assign compute resources to AI workloads and networking workloads concurrently such that constraints or criteria of both are satisfied, which may increase the reliability of the AP to concurrently support AI and networking workloads by facilitating more predictable and/or deterministic workload execution timelines and network performance. Further, by scheduling an execution order of AI workloads, the network node may efficiently and predictably mitigate an impact of scenarios in which the AP is unable to simultaneously execute of a complete set of requested AI workloads in a manner that is transparent to the applications at the AP. By efficiently and predictably mitigating the impact of such scenarios in a manner that is transparent to the applications at the AP, the network node may reduce or avoid a re-routing of workload requests in accordance with sending fewer workload request rejections, which may facilitate reduced latency and a greater user experience for various services provided by the AP, among other benefits.

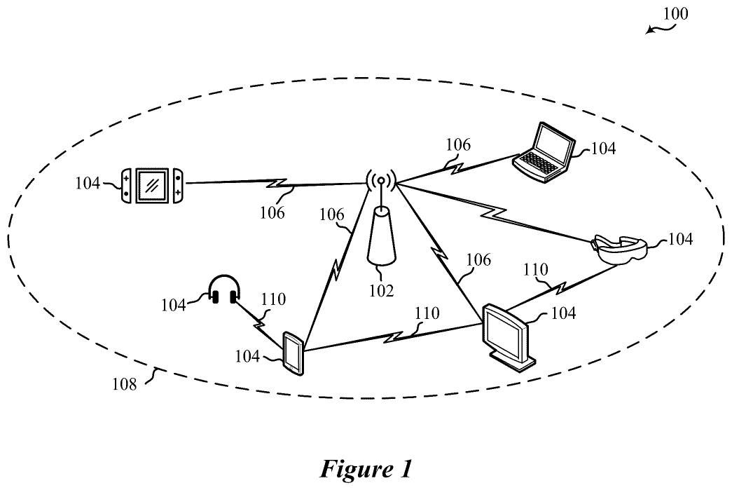

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications having high throughput or low-latency requirements, or may provide lossless audio to one or more other devices. For example, the AP 102 or the STAs 104 may support applications and/or use cases that expect ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communication (hereinafter also referred to as “Wi-Fi communication” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble may be defined by the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communication. For example, the APs 102 or STAs 104, or both, also may be capable of communicating over licensed operating bands. In licensed operating bands, multiple operators may have respective licenses to operate in the same or overlapping frequency ranges. Such licensed operating bands may map or correspond to frequency range designations of FR1 (410 MHz-7.125 GHz), FR2 (24.25 GHz-52.6 GHz), FR3 (7.125 GHz-24.25 GHz), FR4a or FR4-(52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Any transmission by an AP 102 or a STA 104 within a BSS may involve transmission on the primary 20 MHz channel. As such, in some systems, the transmitting device may contend on and win a TXOP on the primary channel to transmit anything at all. However, some APs 102 and STAs 104 supporting ultra-high reliability (UHR) communication or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, in scenarios in which a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Some processes, methods, operations, techniques or other aspects described herein may be implemented, at least in part, using an AI program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects of wireless communication. For example, an AI/ML model may be trained to identify patterns or relationships in data observed in a wireless communication network 100. An AI/ML model may support operational decisions implemented by one or more wireless communication devices relating to aspects described herein that are associated with (such as pertain to, impact, define, or support) wireless communication networks or services. For example, an AI/ML model may be utilized for supporting or improving aspects such as reducing signaling overhead (such as by CSI feedback compression), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of one or more parameters of the AI/ML model, such as weights and biases. Weights may indicate relationships between specific input data and specific outputs of the AI/ML model, and biases are offsets that may indicate a starting point for outputs of the AI/ML model. An example AI/ML model operating on input data may start at an initial output based on the biases and update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates of each client/AP, BSS/QoS load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) at which a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communication. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

Some APs 102 may lack support for packet termination to provide application services. In other words, beyond providing network access and packet routing capabilities, some APs 102 may not operate a role in terminating packets from connected clients (such as STAs 104) to provide application services. Some other APs 102, in addition to providing wired and/or wireless connectivity to one or more STAs 104, may support one or more application services. For example, some APs 102 may support intelligence (such as AI) at the edge to provide one or more services at the edge. Such APs 102, for example, may offer a platform to support various types of application services (in addition to solving a “last mile” or “last section” of connectivity). Some of such application services may be assisted with AI to provide a richer experience by terminating various packet flows in an AP 102 and facilitating various vendors and/or operators to introduce applications at the AP 102 (such as on top of the AP 102). For example, an AP 102 may support an application store to enable application developers, vendors, and/or operators to place applications within the AP 102 and tap into a set of compute capabilities of the AP 102.

In some networks, however, APs 102 may lack a system or mechanism according to which the APs 102 may manage or control such applications, which may lead to unmanaged or uncontrolled requests for compute resources at the APs 102. Such unmanaged or uncontrolled requests for compute resources at the APs 102 may, in turn, compromise connectivity elements of the wired and/or wireless transports (such as IEEE, 3GPP, PON, DOCSIS, and/or Ethernet) that the APs 102 support as compute resources of the AP 102 are overtaken for application workload execution. Additionally, some APs 102 may lack a system or mechanism according to which the APs 102 may enable the various applications to access compute resources across the wireless communication network 100, the cloud, and/or other compute nodes, elements, or units.

In some implementations, a network node (such as an AP 102 or another network node) may support an operating system, which may be understood or referred to herein as a network AI operating system (such as a network AI OS or “N-AIOS”), to enable one or more applications to use compute resources of the AP 102, of other nodes within the wireless communication network 100, and/or of one or more cloud devices, without compromising a level of connectivity that the AP 102 is expected to provide. Such an AP 102 may support AI compute capabilities, such as one or more processors that are individually or collectively capable of at least a threshold quantity of operations per second. Such a threshold quantity of operations per second may be defined on a basis of a trillion of operations per second (TOPS), with the AP 102 supporting 10 TOPS, 20 TOPS, 40 TOPS, or 50 TOPs, among other examples. The network node may use the operating system to manage various types of application workloads (including AI workloads) alongside (such as concurrently with) wireless/wired broadband workloads (such as workloads for communicating broadband traffic, which may be referred to as networking workloads). The network node may use the operating system such that both the application workloads and the wireless/wired broadband workloads co-exist (and satisfy corresponding constraints or criteria) within a same processing system (such as a same processor) or system-on-a-chip (SoC) complex, among other implementation options. In other words, the operating system may support concurrent and timely execution of AI and broadband workloads within a single box (such as within a single wireless communication device, a single network node, a single compute node, or a single processor or processing system within a device or node, among other examples).

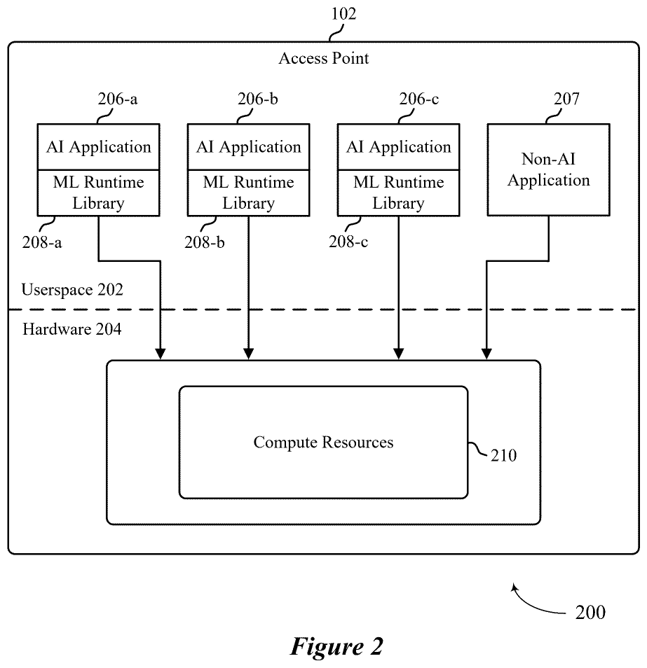

FIG. 2 shows an example AI workload path 200 that supports compute resource orchestration framework for balancing AI workloads and network performance. In some examples, the AP 102 may support one or more applications, such as AI applications, and may use one or more compute resources of the AP 102 to execute workloads of the application. For example, the AP 102 may include or otherwise be associated with (such as offer or support) a userspace 202 and may include hardware 204. The AP 102 may host one or more applications within the userspace 202 of the AP 102 and may use the hardware 204 of the AP 102 to execute, process, perform, and/or calculate one or more workloads associated with (requested by) the applications.

In the example of FIG. 2, the AP 102 may support an AI application 206-a, an AI application 206-b, an AI application 206-c, and a non-AI application 207. Each AI application may be associated with (such as depend on and/or utilize) a ML runtime library. For example, the AI application 206-a may be associated with (such as depend on and/or utilize) an ML runtime library 208-a, the AI application 206-b may be associated with (such as depend on and/or utilize) an ML runtime library 208-b, and the AI application 206-c may be associated with (such as depend on and/or utilize) an ML runtime library 208-c. Although FIG. 2 illustrates an example in which the AP 102 supports three AI applications and one non-AI application, the AP 102 may support any quantity of applications (such as AI applications and/or non-AI applications) without exceeding the scope of the present disclosure.

An AI application may have one or more AI workloads for the AP 102 to execute (such as process, perform, and/or calculate) and the AP 102 may route workload requests corresponding to the AI workloads from the userspace 202 of the AP 102 to the hardware 204 of the AP 102. For example, the AP 102 may route workload requests to compute resources 210 of the AP 102, which may include a memory of the AP 102 and/or one or more processing units (such as a processing unit core) of the AP 102. The memory may include one or more memories (such as one or more memory elements) and may be an example of a DDR memory. The one or more processing units may include one or multiple processing elements (such as one or more processors). The AP 102 may use the one or more processing units for pre-processing an AI workload (such as using a general-purpose central processing unit (CPU) or a graphical processor unit (GPU), which also may be referred to as a “graphics processing unit”) and/or for inferencing an AI workload (such as using a neural processor unit (NPU), which also may be referred to as a “neural processing unit”). The memory and the one or more processing units may be an example of a processing system within the hardware 204 of the AP 102.

Some AI applications that the AP 102 supports may be understood or referred to as edge services, which may be separate from networking applications that the AP 102 uses to enable and manage one or more connectivity elements for one or more wired and/or wireless transports that the AP 102 also supports. For example, networking applications that the AP 102 supports may include a speed test application or a parental control application, among other examples. The AI applications that the AP 102 supports may include an application that supports terminating an IP-camera stream in the AP 102 for computer vision processing (such as to identify human behavior and/or trigger one or more IoT products in response), a turnkey surveillance application in the AP 102 (instead of sending feed to the cloud for inferencing), an application that provides network security on the edge using large language models (as opposed to cloud-based intrusion detection services), and/or an application that provides parental control using a conversational request and a corresponding configuring of the AP 102, among other examples.

AI workloads may use a relatively larger quantity of system resources as compared to non-AI workloads. For example, an AI workload may use a relatively larger quantity of system resources to perform a relatively greater quantity of mathematical computations in a relatively short amount of time. System resources may include DDR resources, CPU resources, GPU resources, and/or NPU resources, among other examples. AI workloads may be defined with metrics (such that the AI workloads may be measured with or using metrics) such as TOPS in accordance with the relatively large volume of data that is to be operated on (such as with matrix algebra) in a relatively short amount of time. By way of example, detecting a known human face from a video stream may occupy approximately 30 milliseconds of compute for a 40 TOPS machine and may involve rescheduling a relatively large amount of DDR resources used by non-AI workloads.

The AP 102 may support a system architecture to support AI compute capabilities. For example, the AP 102 may include AI compute resources within an SoC of the AP 102, or the AI compute resources may be tethered to (such as coupled with or to) the SoC of the AP 102. In some examples, the AP 102 may support a hybrid mode according to which different portions of an AI workload are performed on different devices. For example, an edge device (such as the AP 102) may perform a first portion of AI computations, and a cloud node or device may perform a second portion of AI computations.

Due to a size of AI workloads, some AI workloads left unmanaged may over-consume system resources and cause starvation in an entire platform for other workloads. For example, an AI workload left uncontrolled may create a large amount of stress on the AP 102 in terms of compute resource availability (which may go to a relatively small level, such as zero, depending on the workload size), thermal constraints, packaging constraints, and/or connectivity expectations. In other words, due to a relatively large quantity of mathematical computations concentrated into a single AI model, an AI inference may tend to utilize compute engines, DDR, cache, and other system resources (while relatively smaller workloads, executed using relatively smaller models, may run with a lesser impact on system resources). Factors such as CPU usage, DDR load and usage, power usage, and/or thermal information may play a relatively large role in determining an outcome of overall system performance, such that an AI workload has a potential to significantly impact the overall system performance (by way of occupying such system resources).

Further, in examples in which the AP 102 supports multiple AI applications each working with a respective AI library (such as an ML runtime library), multiple simultaneous AI workloads may end up consuming system resources in an uncontrollable way. For example, an AI application on the AP 102 may work with an AI library and the AI application may run a set of model computations entirely within a memory space of (dedicated to) the AI application. An inference originating from this AI application may utilize system resources in an individualized way (in accordance with the model computations being performed entirely within its own memory space). In examples in which there are multiple of such AI applications running alongside each other, the overall utilization of system resources may be uncontrollable and unpredictable, which may lead to an adverse impact on other tasks of the AP 102 (such as broadband services).

By way of further example, the AI application 206-a may use a first model that supports a first inference time on one or more processors (such as one or more CPUs, one or more NPUs, and/or one or more GPUs) of 20 microseconds, the AI application 206-b may use a second model that supports a second inference time on the one or more processors of 500 microseconds, the AI application 206-c may use a third model that supports a third inference time on the one or more processors of 1 millisecond, and an additional AI application may use a fourth model that supports a fourth inference time of 300 microseconds. In such examples, the AP 102 may be unaware of a specific order in which the AI applications make a request for an inference, which may result in a use of compute resources by the AI applications in a manner that is inconsistent with their relative inference time constraints. Further, in examples in which some network (such as broadband) traffic is running at the same time and the system resources (such as the compute resources 210) are actively being used by the AI applications and networking workloads, an outcome of the AI workloads and the network traffic may be unknown and unpredictable. Thus, the AP 102 may benefit from additional capabilities for managing AI and networking workloads concurrently to control (and balance) the AI computations originating from the AI applications alongside network traffic to and from the AP 102.

Further, in some scenarios, the AI compute capabilities of the AP 102 may be insufficient to support one or a set of AI workloads. For example, the on-chip resources of the AP 102 may be insufficient to satisfy complex AI workloads or multiple AI workloads concurrently. In such examples, the AP 102 may supplement on-chip resources with additional compute resources, which may be on-device or within a device that is tethered to (such as coupled with or to) the AP 102. Such an addition of compute resources, however, may eventually reach a limit of how many compute resources the AP 102 is able to operate and manage. For example, while a relatively smaller model may support an inference time on an order of microseconds, some other AI workloads (such as a computer vision workload executed using a computer vision model) may occupy system resources (such as the compute resources 210) on an order of seconds.

By way of example, in a scenario in which a camera is streaming 30 frames per second and in which 1 frame takes on the order of seconds to perform an inference, 30 frames may use system resources for more than a minute. DDR read/write operations may increase within this time, which may lead to an unusable system within the AP 102 for a duration of the frame inferences. By way of further example, some large language models may use approximately 4 gigabytes (GB) of DDR memory to load on the system, which may be too much for the AP 102 to load into the memory of the AP 102. Further, even in examples in which the memory of the AP 102 is sufficient to store such large language models, the AP 102 may not be able to perform inferences using such a model because of limitations at the DDR of the AP 102 and a thermal capacity of the AP 102. Thus, the AP 102 may benefit from additional capabilities according to which the AP 102 may coordinate with one or more other nodes or devices to support a distribution of compute resources with variable levels of capacities over on-chip, on-device, on-cloud, and/or on-network compute resources. In other words, the AP 102 may benefit from a virtualization of compute resources across various nodes or devices within the cloud or network, such that AI workload execution may reside at any level of the network infrastructure (including on a local area network or a wide area network).

In some implementations, the AP 102 may support such additional capabilities by using an operating system, such as a network AI operating system and orchestration framework, that provides an architecture and framework via which the AP 102 may effectively manage both compute and networking (such as broadband) workloads without sacrificing or unsuitably impacting either. In such implementations, the AP 102 may leverage the operating system to provide “knobs” by which the AP 102, or a user or operator of the AP 102 or another network node, may tailor a prioritization of compute workloads or networking workloads or otherwise balance compute and networking workloads to achieve a target mode of operation. For example, a user or operator may use the operating system to select an aggressiveness of AI workload (such as inference) execution, to select an aggressiveness of networking workload execution, or to select a combination of both.

As described herein, AI workloads and networking workloads may compete for the same finite system resources, including CPU cycles, memory bandwidth, cache space, and thermal capacity. AI workloads may exhibit bursty, intensive resource demands that may overwhelm a capacity of an AP. Unmanaged AI workloads may render networking functions and/or applications inoperable or to function poorly, causing packet drops, increased latency, and degraded quality of service. The operating system and orchestration framework described herein may balance resource allocation between AI workloads and networking workloads, increasing the likelihood that network workloads are not starved out by (not always pre-empted by) AI workloads. The techniques described herein enable APs to support AI applications and perform networking responsibilities in balance or to otherwise satisfy one or more performance indicators (such as to meet or exceed a first set of performance indicators that measure AI application performance and/or a second set of performance indicators that measure network performance).

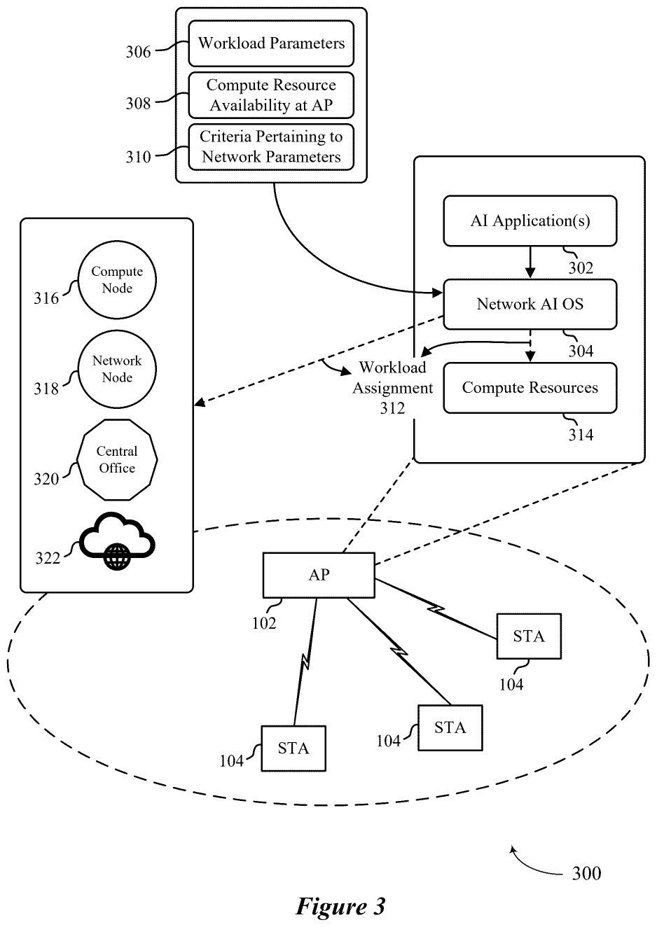

FIG. 3 shows an example wireless communication network 300 that supports compute resource orchestration framework for balancing AI workloads and network performance. The wireless communication network 300, which may be an example of the wireless communication network 100, may include an AP 102 and one or more STAs 104 served by the AP 102. The wireless communication network 300 may be an example of a wireless network within which the AP 102 operates. In some implementations, the AP 102 may support one or more systems, mechanisms, schemes, or procedures according to which the AP 102 may balance workloads of one or more AI applications 302 of the AP 102 and one or more networking workloads of the wireless communication network 300.

For example, the AP 102 may support an operating system 304 (illustrated in the example of FIG. 3 as a “Network AI OS”) according to which the AP 102 may manage or control workload requests originating from the AI applications 302. For example, the AP 102 may receive a set of workload requests from the AI applications 302 corresponding to a set of AI workloads and may use the operating system 304 to perform a workload assignment 312. In accordance with performing the workload assignment 312, the AP 102 may assign compute resources 314 of the AP 102 to the set of AI workloads and/or may assign compute resources of one or more other nodes or devices to the set of AI workloads. The one or more other nodes or devices may include one or more compute nodes 316, one or more network nodes 318, one or more central office devices 320, or one or more cloud nodes 322. The one or more other nodes or devices may include edge nodes, dedicated processing nodes, APs 102, STAs 104, or any other nodes capable of executing an AI workload. For example, a set of available compute nodes or devices may include one or more components of the AP 102, a processing chip connected (such as via Ethernet, among other examples) with the AP 102, one or more cloud compute nodes or devices, and/or one or more AP mesh nodes or devices, among other examples.

In some examples, each workload request may convey or indicate a set of workload parameters 306 of a corresponding AI workload. For example, the AI applications 302 may send a first workload request corresponding to a first AI workload and a second workload request corresponding to a second AI workload. The first workload request may convey or indicate a first set of workload parameters 306 of the first AI workload and the second workload request may convey or indicate a second set of workload parameters 306 of the second AI workload. In some examples, a set of workload parameters 306 of a requested AI workload may indicate one or more expectations, one or more constraints, or other information that defines or characterizes the requested AI workload. For example, a set of workload parameters 306 of a requested AI workload may indicate a priority of the requested AI workload and/or an inference latency constraint of the AI workload, among other AI workload information. In some examples, the AP 102 may derive (such as determine or ascertain) a priority of a requested AI workload in accordance with an indicated inference latency constraint.

In some implementations, the operating system 304 may perform the workload assignment 312 by assigning compute resources to the requested AI workloads in accordance with the workload parameters 306 of the requested AI workloads, a compute resource availability 308 at the AP 102, and one or more criteria 310 pertaining to a set of network parameters of or in the wireless communication network 300 in which the AP 102 operates. The compute resource availability 308 at the AP 102 may be defined by a memory load usage (such as a DDR load usage) at the AP 102, a memory bandwidth usage (such as a DDR bandwidth usage) at the AP 102, a processor utilization (such as a CPU, a GPU, an NPU, or a cache utilization) at the AP 102, and/or a thermal constraint at the AP 102, among other examples.

The one or more criteria 310 pertaining to the network parameters may be (or may include, be derived from, be calculated using, or otherwise be based on) a threshold packet rate, a threshold QoS level, a threshold packet delay, and/or a threshold amount of buffered network traffic, among other examples. Likewise, the network parameters may include a packet rate, a QoS level, a packet delay, and/or an amount of buffered network traffic, among other examples. The AP 102 (or any other network node that runs the operating system 304) may receive (such as receive signaling, measure, calculate, identify, obtain, ascertain, and/or otherwise determine) an indication of the network parameters. The AP 102 may use the operating system 304 to satisfy the criteria 310 by maintaining one or more of the packet rate, the QoS level, the packet delay, and/or the amount of buffered network traffic at values that satisfy the threshold packet rate, the threshold QoS level, the threshold packet delay, and/or the threshold amount of buffered network traffic, respectively.

In some implementations, the operating system 304 may support dynamic resource throttling between AI workloads and networking (such as broadband) workloads. For example, the operating system 304 may support or facilitate a policy-based framework to perform informed decisions to utilize available compute resources in accordance with the full system resources and user expectations. In such examples, the operating system 304 may support or facilitate the policy-based framework to resolve contention for the available system resources by controlling one or more blocks in the system and throttling an execution related to the one or more blocks. A policy of an AI workload may include a thermal impact, a CPU impact, and/or a DDR impact, among other examples. Such one or more blocks may include a Wi-Fi networking block and an AI inferencing block, which the operating system 304 may throttle to balance, prioritize, or otherwise control a Wi-Fi packet rate and/or an inference speed. For example, the operating system 304 may support both Wi-Fi packet rate throttling and inference throttling such that a user or operator of the operating system 304 may achieve a target balance or prioritization between network performance and AI workload execution. In some examples, the operating system 304 may perform the workload assignment 312 in accordance with dynamic resource throttling by considering (such as accounting for) factors including DDR bandwidth usage, CPU utilization, DDR load usage, thermal constraints, and/or inference latency constraints, among other examples.

Additionally, or alternatively, the operating system 304 may support AI compute virtualization (which may be seamless or transparent to the AI applications 302 in the userspace of the AP 102). For example, using the operating system 304, the AP 102 may create a virtual environment of various compute resources (including AI or ML compute resources) that the operating system 304 may utilize for a variety of inference tasks. In some examples, such compute resources may include supplementary compute resources attached to the AP 102 to increase the AI inference capacity of the AP 102 and performance of the whole system, among other compute resources within local or wide area network that the operating system 304 may assign to one or more AI workloads of the AP 102.

For example, an AI or ML inference may consume a relatively large quantity of CPU cycles and may place stress on a DDR memory subsystem, a thermal management subsystem, and network performance and management subsystems. The operating system 304 may alleviate at least some of such stress by virtualizing the inferences (the AI or ML workloads) across compute resources within an AI platform of the AP 102 and within the proximate local or wide area network. For example, the operating system 304 may assign compute resources of any component within the AP 102 or any node or device within the local or wide area network to an AI workload of the AP 102 in accordance with a compute demand for the AI workload. In examples in which the operating system 304 receives information indicating or otherwise determines that compute resources within the local or wide area network are exhausted or otherwise unavailable, the operating system 304 may supplement available compute resources with compute resources from the cloud or a data center, among other examples. For example, the operating system 304 may assign compute resources of the one or more compute nodes 316, the one or more network nodes 318, the one or more central office devices 320, and/or the one or more cloud nodes 322 to one or more AI workloads.

Additionally, or alternatively, the operating system 304 may support AI software virtualization. For example, one or multiple of various nodes or devices may run (such as implement or operate) the operating system 304, in part or in full. By way of example, the AP 102, a cloud device, or a central office device (such as a carrier central office device) may run the operating system 304 and may assign workloads across various nodes or devices. For example, the operating system 304 may split an AI workload into portions (such as chunks) and may distribute the portions of the AI workload to one or more of various nodes or devices. Additionally, or alternatively, the operating system 304 may assign compute resources of a first node or device to one or more first AI workloads and may assign compute resources of a second node or device to one or more second AI workloads. In such examples in which the operating system 304 supports AI software virtualization, the operating system 304 may be within the AP 102 (as shown in the example of FIG. 3), within another node or device, or distributed (such as virtualized) across multiple nodes or devices. For example, although some operations are illustrated and described in an example in which the AP 102 runs the operating system 304, any one or more operations described as being performed by the AP 102 or the operating system 304 may be performed by any network node (such as the one or more compute nodes 316, the one or more network nodes 318, the one or more central office devices 320, and/or the one or more cloud nodes 322).

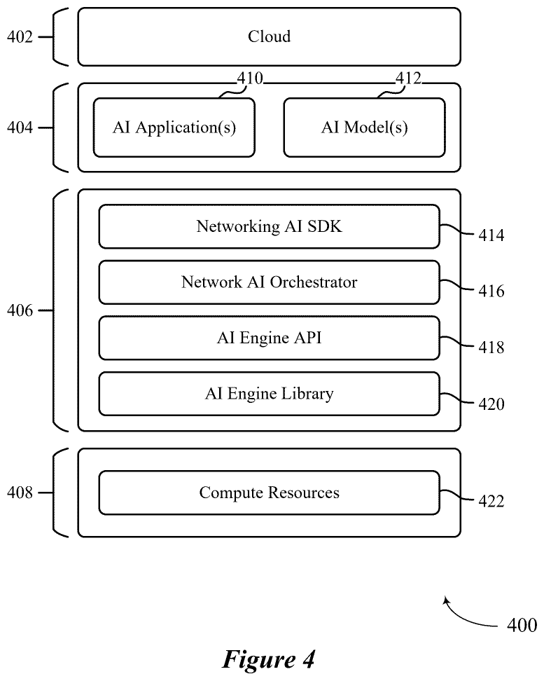

FIG. 4 shows an example AI gateway 400 that supports compute resource orchestration framework for balancing AI workloads and network performance. The AI gateway 400 may have multiple layers (such as stages) including a first layer 402 associated with or corresponding to the cloud, a second layer 404 associated with or corresponding to AI applications and models, a third layer 406 associated with or corresponding to an operating system (such as the operating system 304 as illustrated by and described with reference to FIG. 3), and a fourth layer 408 associated with or corresponding to device hardware. In some implementations, one or more nodes or devices, such as an AP 102, may support operations that involve, leverage, use, or depend on one or more layers of the AI gateway 400 to execute AI workloads concurrently with networking workloads in accordance with workload parameters, compute resource availability, and/or one or more criteria pertaining to a set of network parameters.

The second layer 404 may include a set of AI applications 410 and a set of AI models 412. In some examples, each AI application 410 may be associated with (such as executed using) a respective AI model 412. For example, a first AI application 410 may be executed using a first AI model 412 and a second AI application 410 may be executed using a second AI model 412. In some aspects, an AI application 410 within the second layer 404 may be unaware of the presence of other AI applications 410 within the second layer 404. The third layer 406, associated with or corresponding to the operating system, may include a networking AI software development kit (SDK) 414, a network AI orchestrator 416, an AI engine application programming interface (API) 418, and an AI engine library 420. A node or device may use any combination of one or more of such components to support one or more operations described as being performed by an operating system (such as a network AI operating system), among other examples.

The fourth layer 408, associated with or corresponding to the device hardware, may include compute resources 422. The compute resources 422 may include any combination of one or more processors and/or one or more memories. For example, the compute resources 422 may include one or more CPUs, one or more GPUs, one or more NPUs, one or more neural signal processors (NSPs), one or more neuro-symbolic processors, one or more DDR memories (such as memories that are associated with or otherwise involve or use DDR memory technology), one or more small AI compute engines, and/or one or more large AI compute engines, among other examples. In some implementations, NPUs and NSPs may be used interchangeably. In some aspects, a CPU may process an AI workload in a relatively longer amount of time as compared to an NPU. For example, a CPU may perform an object detection inference in approximately 3 seconds and an NPU may perform the object detection inference in approximately 30 milliseconds.

The operating system associated with or corresponding to the third layer 406 may assign the compute resources 422 to one or more AI workloads. In some examples, the operating system associated with or corresponding to the third layer 406 may perform AI workload assignments in accordance with a dynamic resource throttling by considering (such as accounting for) various factors. Such factors may include DDR bandwidth usage, CPU utilization, DDR load usage, thermal constraints, and/or inference latency constraints, among other examples.

For example, a rise in Wi-Fi or other networking traffic may lead to a relatively large amount of traffic with a DDR of an AP 102 and/or a relatively high processor utilization (such as CPU, or CPU core, utilization). At the rise of such traffic, and in examples in which there are one or more AI workloads (such as AI or ML inferences) driving toward the DDR and/or the processor, the operating system may provide a systemwide deterministic result, such as via a policymaker that performs scheduling decisions (such as the network AI orchestrator 416, among other examples). In such examples in which the DDR bandwidth and/or the processor is being utilized by Wi-Fi or other networking traffic, the operating system (such as a network node running the operating system) may schedule the AI workload(s) in accordance with an available DDR bandwidth and/or an available processor utilization. For example, in scenarios in which Wi-Fi traffic is using approximately 80% of the DDR bandwidth and in which 20% of the DDR bandwidth may satisfy one or more expectations (such as an inference latency constraint) of an AI workload, the operating system (via, for example, the network AI orchestrator 416) may schedule the AI workload in an inference queue in accordance with 20% of the DDR bandwidth being available (such as in accordance with an assumption that the operating system is limited to 20% of the DDR bandwidth for AI workloads).

Additionally, or alternatively, the operating system (such as the network node running the operating system) may throttle the Wi-Fi or other networking traffic (in accordance with a user or operator instruction and/or one or more upper or lower limit network performance bounds, among other examples) to provide more DDR bandwidth and/or processor resources for AI workloads. For example, the network node may adjust one or more threshold network parameters up or down to prioritize AI workload execution or network performance or to target user or operator defined balance between AI workload execution and network performance. Throttling network traffic may include increasing or decreasing a threshold packet rate and/or increasing or decreasing a threshold QoS, among other examples. In some implementations, the network node may trigger flow control on the networking and wireless port (Ethernet and/or Wi-Fi) to lower the inflow and outflow of traffic from the connecting links, which may reduce the demands on the system resources and enable a lower latency, a more accurate, and/or a more consistent AI workload completion.

By way of further example, system resources may include a finite amount of DDR space, and the operating system may allocate space of one or more DDR memories to one or more AI models 412 in accordance with workload parameters, compute resource availability, and/or one or more criteria pertaining to a set of network parameters. Some AI models 412 may be relatively large in size, such that hosting such AI models 412 may occupy a relatively large percentage of available memory. For example, a computer vision model may be approximately 20 megabytes (MB). In some examples, the compute resources 422 (which may be of an AP 102 that hosts the AI applications 410) may be insufficient to host a complete set of the AI models 412 in the DDR and to keep the AI models 412 loaded. In such examples, the operating system may decide (such as identify, select, or determine) to selectively or conditionally load (such as input) and unload (such as remove) one or more AI models 412. The operating system may decide to load and unload one or more AI models 412 in accordance with respective priorities of the one or more AI models 412 (and in a manner that is transparent to the AI applications 410). For example, the operating system may use a model priority value or metric to determine which AI models 412 to load and unload. Additionally, or alternatively, the operating system may load an AI model 412 at a time at which an inference for a corresponding AI application 410 is scheduled and may unload the AI model 412 after executing the inference. In such examples, the operating system may load and unload AI models 412 to the DDR over time in accordance with for which one or more AI applications 410 the compute resources 422 are being used.

For example, a node, device, user, or operator may configure the operating system to allocate an upper limit (such as an upper limit of 50 MB) for AI workloads. In scenarios in which there are a total of 10 AI models 412 to be loaded on the system, which may occupy approximately 100 MB of DDR loading memory, the operating system may load one or more higher priority AI models 412 to the DDR and may offload (such as remove or omit) one or more lower priority AI models 412 from the DDR. In such scenarios, the operating system may reload the one or more of the lower priority AI models 412 in accordance with a model priority. For example, a relatively lower priority AI model 412 may be loaded after an inference by a relatively higher priority AI model 412 is executed, such that the relatively lower priority AI model 412 may occupy the place (such as DDR memory) of the relatively higher priority AI model 412 in the DDR after the relatively higher priority AI model 412 is used. In scenarios in which there is an AI workload for an offloaded AI model 412, the operating system may reload that AI model 412 to the DDR for execution of the AI workload. In such implementations, the operating system (such as a network node using the operating system) may control the DDR usage for storing AI models 412. Loading and offloading an AI model 412 may involve loading the AI model 412 from a relatively static memory to a relatively more dynamic memory (such as the DDR) and offloading the AI model 412 from the relatively more dynamic memory to the relatively static memory, among other examples.

Further, in some implementations, the operating system may selectively assign compute resources of one or more nodes, devices, or components to one or more AI workloads in accordance with a thermal constraint (such as a thermal constraint at the AP 102 that hosts the AI applications 410). For example, the operating system may track (such as monitor) one or more thermal metrics at the AP 102 and may assign compute resources to AI workloads in accordance with the one or more thermal metrics. A thermal metric at the AP 102, which may measure a temperature (such as a power amplifier (PA) temperature), may increase in scenarios in which the AP 102 is performing (such as transmitting and/or receiving) Wi-Fi or other networking traffic. A thermal metric at the AP 102, which may measure a temperature (such as a GPU or NSP temperature, among other processing units or components of the AP 102), may increase in scenarios in which the AP 102 performs large amounts of AI workloads.

In some examples, the operating system may assign compute resources of a different node or device to one or more AI workloads in accordance with detecting that a thermal metric at the AP 102 is at or nearing a threshold value. Alternatively, the operating system may assign compute resources of the AP 102 to one or more AI workloads in accordance with detecting that the thermal metric at the AP 102 is sufficiently below the threshold value. Additionally, or alternatively, the operating system may schedule one or more AI workloads in one or more workload queues (for later execution) in accordance with detecting that a thermal metric at the AP 102 is at or nearing a threshold value. Additionally, or alternatively, the operating system may throttle (such as flow control, such as decrease) Wi-Fi or other networking traffic in accordance with detecting that a thermal metric at the AP 102 is at or nearing a threshold value. In such examples, the operating system may assign compute resources of the AP 102 to one or more AI workloads in accordance with throttling the Wi-Fi or other networking traffic. The operating system may determine whether to assign an AI workload to another node or device (which may incur additional latency to the AI workload execution timeline), to schedule the AI workload in a workload queue (which also may incur additional latency to the AI workload execution timeline), or to throttle Wi-Fi or other networking traffic (to be able to assign compute resources of the AP 102 to the AI workload, which may have a relatively lower latency execution timeline) in accordance with a priority of the AI workload.

In some implementations, the operating system may run the AI applications 410 (such as AI workloads of the AI applications 410) in accordance with a per-workload (such as per-inference) priority, which may be pre-defined or signaled via a workload request. For example, the operating system may prioritize one or more AI workloads that are in a direct path of a critical or otherwise high priority decision because such AI workload(s) may have a relatively low inference latency constraint. In some examples, the operating system (such as the AI orchestrator 416, among other examples) may schedule AI workloads in accordance with respective latency constraints. For example, the operating system may schedule a relatively higher priority AI workload in a relatively higher priority workload queue and may schedule a relatively lower priority AI workload in a relatively lower priority workload queue.

For example, a smart traffic classifier may expect a flow identification decision within a relatively short amount of time (such as approximately immediately) from a time at which a new flow is created. The system may be unable to wait for this decision because there may be a relatively large quantity of packets waiting for the data path packet routing and, in such examples, the operating system may schedule a corresponding AI workload in a relatively high (such as highest) priority workload queue. By way of further example, an AI workload associated with (that supports or results in) Wi-Fi interference detection (such as an AI workload that is part of monitoring for Wi-Fi interference) may be absent of a latency constraint. In such examples, the operating system may schedule the AI workload in a relatively low (such as lowest) priority workload queue.

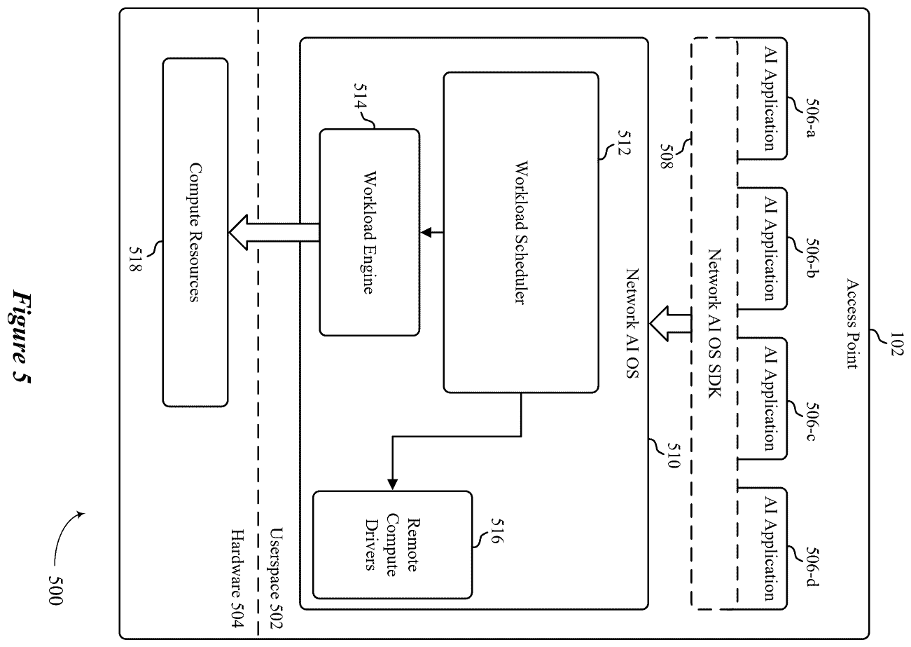

FIG. 5 shows an example AI workload path 500 that supports compute resource orchestration framework for balancing AI workloads and network performance. An AP 102, which may be an example of corresponding devices illustrated and described herein, may implement the AI workload path 500 to route workload requests from one or more AI applications to a network AI operating system and to one or more compute resources. The AP 102 may include a userspace 502 and hardware 504. In some examples, the AP 102 may host a set of AI applications including an AI application 506-a, an AI application 506-b, an AI application 506-c, and an AI application 506-d and may route workload requests from the AI applications via an operating system SDK 508 to an operating system 510 within the userspace 502. The operating system SDK 508 may be understood or referred to as a network AI OS SDK and the operating system 510 may be understood or referred to as a network AI OS. The SDK 508 may communicate with the operating system 510 via inter-process communication. The operating system 510 may be an example of the operating system 304, as illustrated by and described with reference to FIG. 3.

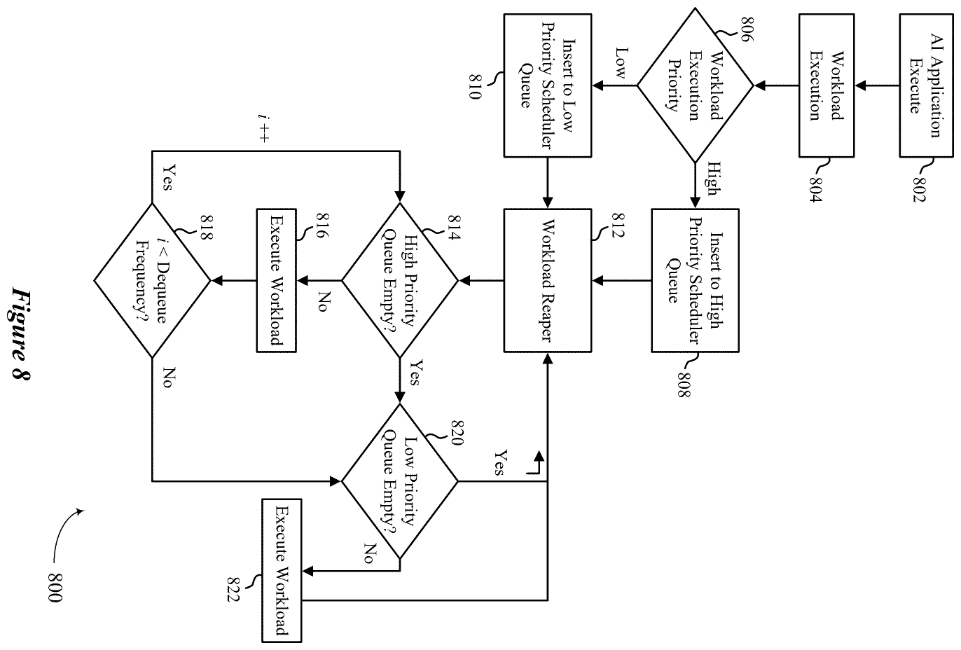

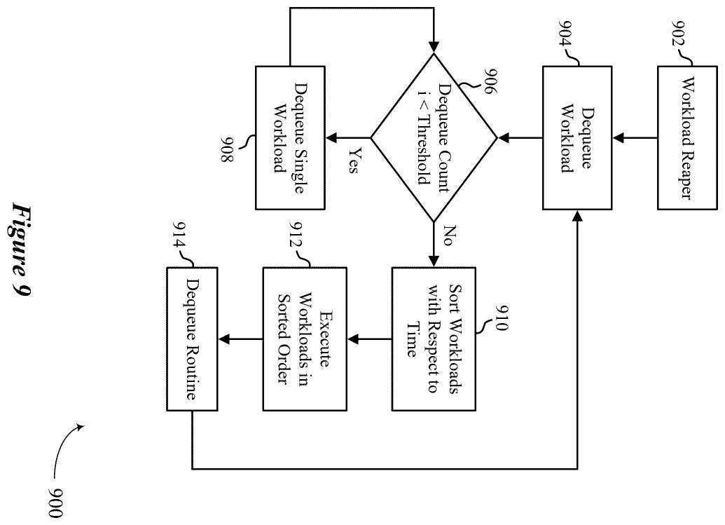

In some implementations, the operating system 510 may include a workload scheduler 512 (such as an inference scheduler), a workload engine 514 (such as an inference engine), and one or more remote compute drivers 516. The workload scheduler 512 may include or operate one or more workload scheduling procedures. The workload scheduler 512 may interface with the workload engine 514 and the one or more remote compute drivers 516. Additional details relating to such workload scheduling procedures are illustrated and described herein, including by and with reference to FIGS. 8 and 9. The workload engine 514 may be associated with (may have or may be configured with) the AI engine API 418 and/or the AI engine library 420 as illustrated by and described with reference to FIG. 4. The operating system 510 may provide a system architecture to convert the platform of the AP 102 to function with various types of compute resources in a seamless way such that the AI applications are unaware of compute virtualization accorded by the operating system 510.

In some implementations, the workload scheduler 512 may schedule one or more AI workloads and may assign the one or more AI workloads to compute resources 518 of the AP 102 or to compute resources of one or more other nodes or devices (which the operating system 510 may communicate with via the one or more remote compute drivers 516). The AP 102 may use the one or more remote compute drivers 516 to assign AI workloads to the one or more compute nodes 316, the one or more network nodes 318, the one or more central office devices 320, and/or the one or more cloud nodes 322, as illustrated by and described with reference to FIG. 3. Each of such other nodes or devices may operate a respective workload (such as inference) engine and/or may have respective compute resources, within or without an AI proxy application associated with or corresponding to one or more of the AI applications hosted by the AP 102. The workload scheduler 512 may communicate with the one or more remote compute drivers 516 in accordance with inter-thread communication.

The compute resources 518 of the AP 102 may be an example of the compute resources 314 and/or the compute resources 422, as illustrated by and described with reference to FIGS. 3 and 4, respectively. For example, the compute resources 518 may include a CPU core, an NSP, one or more prime processors, and/or one or more of various other types of processors and/or memory. In some implementations, the AP 102 may host, within the compute resources 518, a CPU with an NSP (such as an in large AI engine) and a prime core processor (such as in a small AI engine) on-chip. In such implementations, the workload scheduler 512 may interface with the workload engine 514 to selectively use one or more of such resources for a variety of workload types.

In some implementations, the operating system 510 may control and manage the scheduling, DDR offload, and/or other resource throttle tasks or responsibilities associated with (such as caused by, based on, or performed in accordance with) the AI workloads of the AP 102. Further, although four AI applications are illustrated in the example of FIG. 5, the operating system 510 or the AP 102 may support any quantity of AI applications without exceeding the scope of the present disclosure. For example, the operating system 510 may enable any quantity of AI applications to co-exist on the AP 102 (such as within the system) without system resources being used in an unpredictable or uncontrollable way. Further, although the operating system 510 is illustrated as being within the AP 102 in the example of FIG. 5, any one or more nodes or devices within or associated with (such as having access to or connected to a node or device that has access to) a wireless network may support (such as implement and/or run) the operating system 510. In examples in which a node or device different than the AP 102 runs the operating system 510, the AP 102 may transmit, to the other node or device, information indicative of one or more workload requests, information indicative of one or more network parameters, information indicative of a compute resource availability at the AP 102, and/or information indicative of one or more criteria pertaining to the one or more network parameters. The AP 102 may receive information indicative of an assignment of one or more AI workloads from the other node or device, depending on an analysis of the information provided by the AP 102 by the operating system 510 at the other node or device.

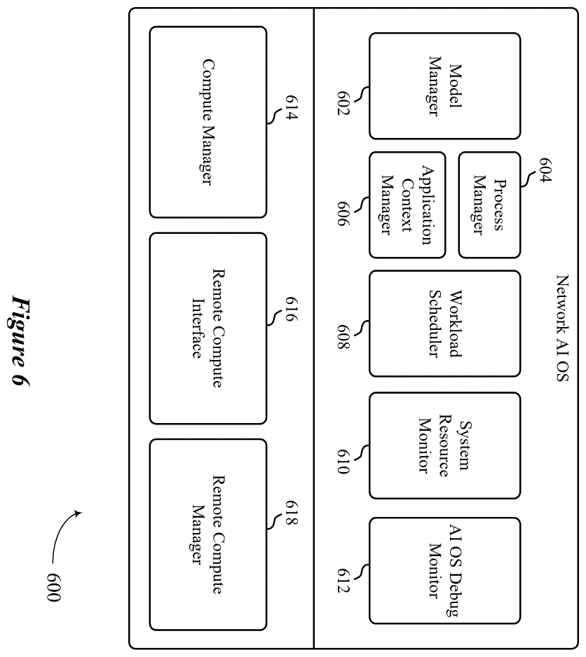

FIG. 6 shows an example operating system 600 that supports compute resource orchestration framework for balancing AI workloads and network performance. The operating system 600, which may be understood or referred to as a network AI OS, may be an example of the operating system 304 and/or the operating system 510. The operating system 600 may provide an architecture, such as a homogeneous software stack, to concurrently execute AI workloads and networking workloads of an AP 102 in a manner that meets constraints of the AI workloads and that satisfies one or more criteria pertaining to network parameters in or of a wireless network within which the AP 102 operates.

The operating system 600 may include a model manager 602, a process manager 604, an application context manager 606, a workload scheduler 608 (such as an inference scheduler), a system resource monitor 610, and/or an AI OS debug monitor 612 (which may be understood as an AI operating system debug monitor). Additionally, or alternatively, the operating system 600 may include a compute manager 614, a remote compute interface 616, and/or a remote compute manager 618. A node or device, such as an AP 102 or any other node or device, may run or implement the operating system 600 via any one or more of the components or elements of the operating system 600 to assign compute resources to AI workloads while balancing network performance.

The model manager 602 may store a priority of an AI model and model information and may include a buffer manager and a storage tracker. The process manager 604 may include an inter-process communication component and an inter-thread communication component. The process manager 604 may use the inter-process communication component for communication between the SDK 508 and the operating system 510. Additionally, or alternatively, the process manager 604 may use the inter-thread communication component for communication between the operating system 510 and the one or more remote compute drivers 516, as illustrated by and described with reference to FIG. 5.

The application context manager 606 may include an AI application registry and an application recovery component. The workload scheduler 608 may include one or more scheduler procedures, a workload queue delegation component, and one or more workload queues. In some examples, the one or more workload queues may include a first workload queue associated with (such as including) a first compute resource (such as a first processor, such as a CPU) and a second workload queue associated with (such as including) a second compute resource (such as an NSP), among other examples. Additionally, or alternatively, the one or more workload queues may include a first workload queue having or corresponding to a first priority level of AI workloads and may include a second workload queue having or corresponding to a second priority level of AI workloads.

The system resource monitor 610 may include a thermal monitor, a CPU usage monitor, an NPU load monitor, and/or a DDR bandwidth monitor, among other examples. The AI OS debug monitor 612 may include a statistics component, a logging component, a system recovery component, a proxy data collection component, and/or a benchmarking component, among other examples. The compute manager 614 may include a CPU support component and/or an NSP support component within a neural processing engine and/or one or more prime computing components. The remote compute interface 616 may include a workload interface component and a remote compute monitor, which may include or track logs and statistics of one or more workloads assigned to one or more other nodes or devices. The remote compute manager 618 may include a handshake and discovery component, a health monitor (with a compute recovery component), and/or one or more compute drivers, among other examples.

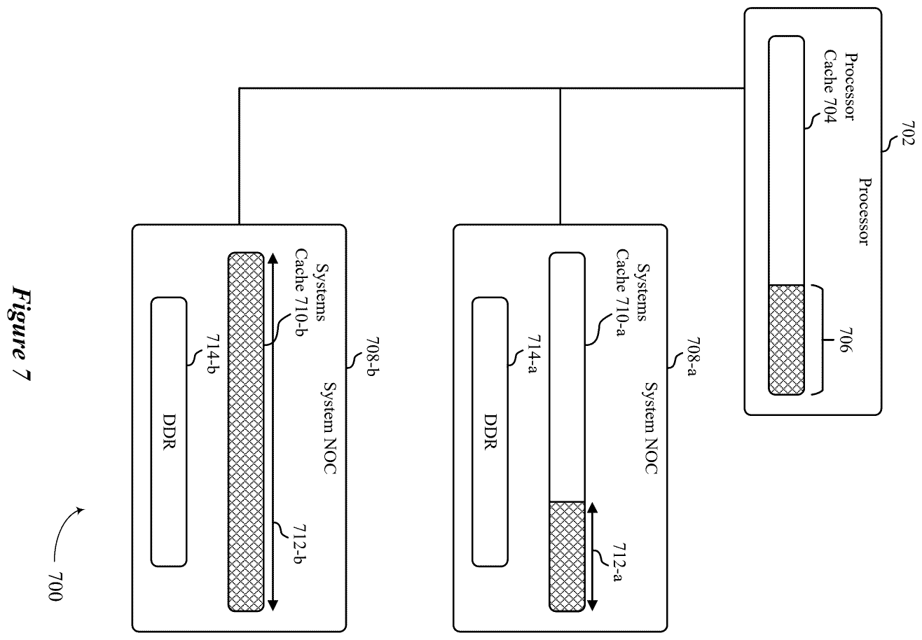

FIG. 7 shows an example cache allocation 700 across AI and networking workloads that supports compute resource orchestration framework for balancing AI workloads and network performance. For example, a network node may use an operating system, such as the operating system 304, the operating system 510, or the operating system 600, to perform the cache allocation 700. In accordance with the cache allocation 700, the network node may allocate (such as partition) a resource of cache between one or more AI workloads and/or one or more networking workloads. In some aspects, cache may be a type of memory that is not dedicated to a specific workload but may play a role in a statistical manner (in accordance with an eviction policy of the cache and a replacement nature of cache lines). By adapting the allocation of cache size to one or more of various workloads, the network node may achieve a suitable or target balance between different workload types (such as between AI workloads and networking workloads).

In some examples, the network node, using the operating system, may allocate cache entirely to a networking workload in accordance with a prioritization of networking workloads over AI workloads. In some other examples, the network node, using the operating system, may allocate cache entirely to an AI workload in accordance with a prioritization of AI workloads over networking workloads. In some other examples, the network node, using the operating system, may partition the cache into multiple portions. In such examples, the network node may allocate a first portion of the cache to a networking workload and a second portion of the cache to an AI workload. The network node may partition the cache in one or more of various quantized patterns, such as 25/75, 50/50, or 75/25. In accordance with partitioning cache into a 25/75 pattern, the network node may allocate 25% of cache resources to a networking workload and may allocate 75% of cache resources to an AI workload, or vice versa.

In the example of the cache allocation 700, the network node may use the operating system to allocate different portions of cache 704 of a processor 702 (such as a CPU) to different workloads. For example, the network node may allocate a portion 706 of the cache 704 to an AI workload and may use a remainder of the cache 704 for one or more networking workloads. Although the cache 704 may be understood or referred to as a processor cache (commonly referred to as L1, L2, and/or L3 cache), additional cache levels in an SoC may be available and may be used as (such as function or act as) a cache for the entire system (and may be understood or referred to as the “Systems Cache”). Such a Systems Cache may act as a final local storage prior to the DDR and may provide additional flexibility and control to manage a usage of the DDR. In such multi-tier cache architectures, in some examples, the network node may assign various “cache-ways” to a specific workload (such as in accordance with a Linux process identifier) to provide determinism in an execution timeline. In an example cache-way based partitioning, the network node may use a portion 712-a of a systems cache 710-a of a System Network-on-Chip (NOC) 708-a (which may be associated with or otherwise include a DDR 714-a). The portion 712-a may be a portion of cache allocated to an AI workload and/or a (portion of a) tightly coupled memory (TCM) allocated to the AI workload. The portion may be 25%, 50% or 75%, among other examples. By way of further example of cache-way based partitioning, the network node may use a portion 712-b of a systems cache 710-b of a system NOC 708-b (which may be associated with or otherwise include a DDR 714-b). The portion 712-b may correspond to a full cache allocation to an AI workload and/or a full TCM allocation to the AI workload. By way of further example, the Systems Cache may be programmed to provide a preferential access to transactions coming from other AI subsystems (such as the NPU, GPU, and/or associated direct memory accesses (DMAs)) to land (such as route, provide, or place) traffic of the other AI subsystems in the Systems Cache before going to DDR.

FIG. 8 shows an example workload scheduling procedure 800 that supports compute resource orchestration framework for balancing AI workloads and network performance. A network node may implement the workload scheduling procedure 800 via a workload scheduler, such as the AI orchestrator 416, the workload scheduler 512, and/or the workload scheduler 608 as illustrated by and described with reference to FIGS. 4, 5, or 6, respectively, of a network AI operating system. The workload scheduling procedure 800 may be an example of a priority-based workload scheduling procedure.

At 802, the network node may execute an AI application. In association with (such as in accordance with) the execution of the AI application, the network node may receive one or more workload requests from or of the AI application. At 804, for example, the network node may start workload execution. At 806, the network node may determine a workload execution priority of a requested AI workload. At 808, in examples in which the workload execution priority is a high priority, the network node may insert (such as add or schedule) the AI workload to a high priority scheduler queue (such as a high priority workload queue). At 810, in examples in which the workload execution priority is a low priority, the network node may insert (such as add or schedule) the AI workload to a low priority scheduler queue (such as a low priority workload queue).

At 812, the network node may select an AI workload, such as via a workload reaper (such as a workload selector). At 814, the network node may determine whether the high priority queue is empty. At 816, in examples in which the high priority queue is non-empty, the network node may select an AI workload from the high priority queue and execute the selected workload. At 818, the network node may determine whether i is less than a dequeue frequency. The variable i (such as a dequeue count) may represent a counter that tracks a quantity of consecutive high priority workloads that have been executed from the high priority queue. The counter i may be initialized to zero at the start of the scheduling procedure and may be incremented by one each time a high priority workload is executed. The dequeue frequency may be a (configurable or network defined) threshold parameter that defines how many high priority workloads can be executed consecutively before the network node checks and potentially executes workloads from the low priority queue. In examples in which i is less than the dequeue frequency, the network node may, at 814, determine whether the high priority queue is empty. In examples in which the high priority queue remains non-empty, the network node may continue to execute AI workloads from the high priority queue until either the high priority queue is empty or until i is no longer less than the dequeue frequency. At 820, the network node may determine whether the low priority queue is empty. At 822, in examples in which the low priority queue is non-empty, the network node may execute an AI workload from the low priority queue. At 812, in examples in which the low priority queue is empty or in which an AI workload from the low priority queue has been executed, the network node may return to 812 and repeat the process to selectively execute AI workloads from one or both of the high priority queue and the low priority queue.

Although only two queues are described in the context of FIG. 8 (such as the high priority queue and the low priority queue), the network node may include any quantity of queues of varying priorities. For example, the network node may include three or more queues. In some examples in which the network node includes three or more queues, the network node may use a single dequeue count and may check and potentially execute one or more workloads from two or more relatively lower priority queues as a result of the single dequeue count meeting or exceeding the dequeue frequency. In some other examples in which the network node includes three or more queues, the network node may use multiple dequeue counts (such as one per relatively higher priority queue) and may check and potentially execute one or more workloads from at least one relatively lower priority queue as a result of a dequeue count of a relatively higher priority queue meeting or exceeding the dequeue frequency. The network node may use a single dequeue frequency or multiple dequeue frequencies in accordance with supporting three or more queues. In examples in which the network node uses multiple dequeue frequencies, the network node may check and potentially execute one or more workloads from a first (relatively lower priority) queue as a result of a first dequeue count of a second (relatively higher priority) queue meeting or exceeding a first dequeue frequency, may check and potentially execute one or more workloads from a third (relatively lower priority) queue as a result of a second dequeue count of the first queue (now relatively higher priority as compared to the third queue) meeting or exceeding a second dequeue frequency, and so on.

FIG. 9 shows an example workload scheduling procedure 900 that supports compute resource orchestration framework for balancing AI workloads and network performance. A network node may implement the workload scheduling procedure 900 via a workload scheduler, such as the AI orchestrator 416, the workload scheduler 512, and/or the workload scheduler 608 as illustrated by and described with reference to FIGS. 4, 5, or 6, respectively, of a network AI operating system. The workload scheduling procedure 900 may be an example of an average inference time-based workload scheduling procedure.

At 902, the network node may select an AI workload, such as via a workload reaper (such as a workload selector). At 904, the network node may dequeue a set of AI workloads. As described herein, the term “dequeue” may refer to removing the set of AI workloads from a queue for execution. At 906, the network node may determine whether a dequeue count (such as a quantity of dequeued AI workloads) i is less than a threshold quantity (such as i<4), as described with reference to FIG. 8. At 908, in examples in which the dequeue count i is less than the threshold quantity, the network node may execute a single workload. At 910, in examples in which the dequeue count i is not less than the threshold quantity, the network node may sort the dequeued workloads with respect to time (such as workload or inference time, such as an inference latency constraint or an expected completion time). At 912, the network node may execute the workloads in the sorted order. At 914, the network node may perform a dequeue routine and return to dequeue another set of AI workloads.

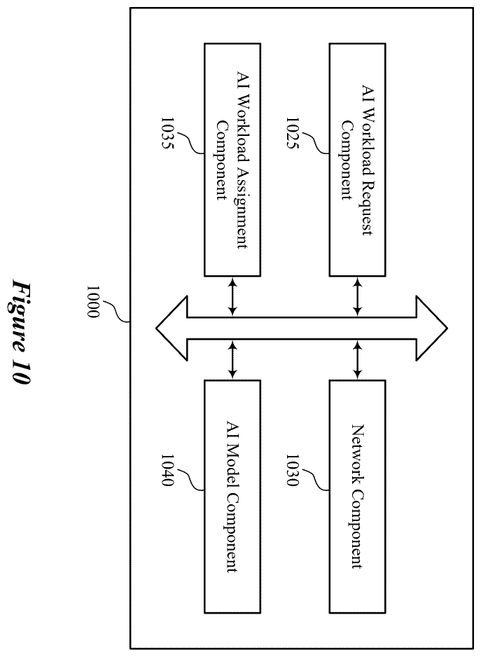

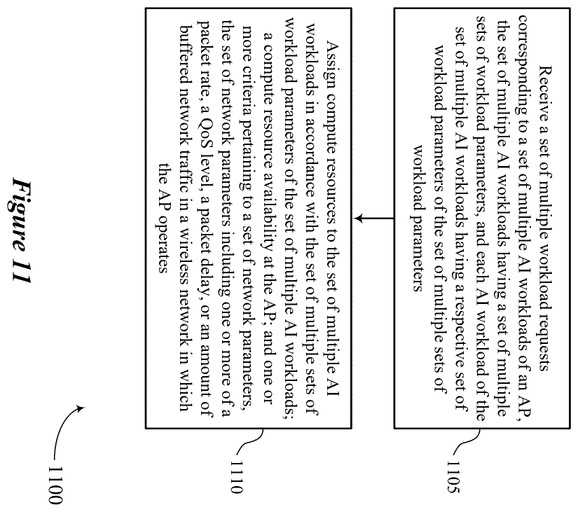

FIG. 10 shows a block diagram of an example wireless communication device 1000 that supports compute resource orchestration framework for balancing AI workloads and network performance. In some examples, the wireless communication device 1000 is configured to perform the process 1100 described with reference to FIG. 11. The wireless communication device 1000 may include one or more chips, SoCs, chipsets, packages, components or devices that individually or collectively constitute or include a processing system. The processing system may interface with other components of the wireless communication device 1000 and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as CPUs, GPUs, NPUs (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, in accordance with being executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in an AP or STA, such as the AP 102 or the STA 104 described with reference to FIG. 1. In some other examples, the wireless communication device 1000 can be an AP or STA that includes such a processing system and other components including multiple antennas. The wireless communication device 1000 is capable of transmitting and receiving wireless communication in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communication conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes a user interface (UI) (such as a touchscreen or keypad) and a display, which may be integrated with the UI to form a touchscreen display that is coupled with the processing system. In some examples, the wireless communication device 1000 may further include one or more sensors such as, for example, one or more inertial sensors, accelerometers, temperature sensors, pressure sensors, or altitude sensors, that are coupled with the processing system. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes an AI workload request component 1025, a network component 1030, an AI workload assignment component 1035, and an AI model component 1040. Portions of one or more of the AI workload request component 1025, the network component 1030, the AI workload assignment component 1035, and the AI model component 1040 may be implemented at least in part in hardware or firmware. For example, one or more of the AI workload request component 1025, the network component 1030, the AI workload assignment component 1035, and the AI model component 1040 may be implemented at least in part by at least a processor or a modem. In some examples, portions of one or more of the AI workload request component 1025, the network component 1030, the AI workload assignment component 1035, and the AI model component 1040 may be implemented at least in part by a processor and software in the form of processor-executable code stored in memory.

The wireless communication device 1000 may support compute resource orchestration in accordance with examples as disclosed herein. The AI workload request component 1025 is configurable or configured to receive a set of multiple workload requests corresponding to a set of multiple AI workloads of an AP, the set of multiple AI workloads having a set of multiple sets of workload parameters, and each AI workload of the set of multiple AI workloads having a respective set of workload parameters of the set of multiple sets of workload parameters. The AI workload assignment component 1035 is configurable or configured to assign compute resources to the set of multiple AI workloads in accordance with the set of multiple sets of workload parameters of the set of multiple AI workloads; a compute resource availability at the AP; and one or more criteria pertaining to a set of network parameters, the set of network parameters including one or more of a packet rate, a QoS level, a packet delay, or an amount of buffered network traffic in a wireless network in which the AP operates.

In some examples, the network component 1030 is configurable or configured to receive an indication of the set of network parameters.

In some examples, the network node assigns the compute resources to the set of multiple AI workloads in accordance with a workload assignment scheme that accounts for the respective set of workload parameters of each AI workload of the set of multiple AI workloads and for the compute resource availability at the AP and satisfies the one or more criteria pertaining to the set of network parameters.

In some examples, the set of network parameters includes a packet rate. In some examples, satisfying the one or more criteria pertaining to the set of network parameters includes the packet rate satisfying a threshold packet rate.

In some examples, the AI workload assignment component 1035 is configurable or configured to schedule a time domain order of an execution of the set of multiple AI workloads in accordance with the set of multiple sets of workload parameters of the set of multiple AI workloads, with the compute resource availability at the AP, and with the one or more criteria pertaining to the set of network parameters.

In some examples, to support scheduling the time domain order, the AI workload assignment component 1035 is configurable or configured to determine whether a dequeue counter of a workload queue satisfies a threshold, and sort a set of multiple of dequeued workloads by execution time, where the time domain order is in accordance with sorting the set of multiple of dequeued workloads.

In some examples, the time domain order of the execution of the set of multiple AI workloads is in accordance with a set of multiple workload queues, and the AI workload assignment component 1035 is configurable or configured to schedule the set of multiple AI workloads in the set of multiple workload queues in accordance with a respective priority of each AI workload of the set of multiple AI workloads, and the AP being unable to simultaneously execute the set of multiple AI workloads in accordance with the compute resource availability at the AP or the one or more criteria pertaining to the set of network parameters.

In some examples, to support scheduling the set of multiple AI workloads, the AI workload assignment component 1035 is configurable or configured to determine whether a dequeue counter of a first queue of the set of multiple of workload queues satisfies a threshold, and execute a workload from a second queue of the set of multiple of workload queues in accordance with the dequeue counter satisfying the threshold, wherein the first queue comprises higher priority workloads than the second queue.

In some examples, the AI model component 1040 is configurable or configured to load a set of multiple AI models to at least one memory in accordance with the time domain order of the execution of the set of multiple AI workloads. In some examples, each AI workload of the set of multiple AI workloads is executed using a respective AI model of the set of multiple AI models.

In some examples, the AI model component 1040 is configurable or configured to offload one or more AI models of the set of multiple AI models from the at least one memory in accordance with one or more priorities of the one or more AI models being relatively lower than one or more other priorities of one or more other AI models of the set of multiple AI models.

In some examples, to support assigning the compute resources to the set of multiple AI workloads, the AI workload assignment component 1035 is configurable or configured to assign a first set of compute resources of the AP to one or more first AI workloads of the set of multiple AI workloads in accordance with the compute resource availability at the AP being able to execute the one or more first AI workloads and satisfy the one or more criteria pertaining to the set of network parameters. In some examples, to support assigning the compute resources to the set of multiple AI workloads, the AI workload assignment component 1035 is configurable or configured to assign a second set of compute resources of the network node or another node to one or more second AI workloads of the set of multiple AI workloads in accordance with the compute resource availability at the AP being unable to additionally execute the one or more second AI workloads and satisfy the one or more criteria pertaining to the set of network parameters.

In some examples, the AI workload assignment component 1035 is configurable or configured to assign a first portion of a set of cache resources to a set of networking workloads of the AP to satisfy the one or more criteria pertaining to the set of network parameters. In some examples, the AI workload assignment component 1035 is configurable or configured to assign a second portion of the set of cache resources to the set of multiple AI workloads in accordance with the set of multiple sets of workload parameters of the set of multiple AI workloads.

In some examples, the AI workload assignment component 1035 is configurable or configured to adjust a threshold network parameter in accordance with receiving the set of multiple workload requests corresponding to the set of multiple AI workloads. In some examples, the one or more criteria pertaining to the set of network parameters include the threshold network parameter.

In some examples, the network node adjusts the threshold network parameter in a first direction to prioritize network traffic in the wireless network in which the AP operates over the set of multiple AI workloads, or a second direction to prioritize one or more of the set of multiple AI workloads over the network traffic in the wireless network in which the AP operates.

In some examples, the compute resources assigned to the set of multiple AI workloads are of the AP, the network node, one or more other network nodes in the wireless network for which the AP manages, one or more cloud compute nodes, and/or one or more edge compute nodes. In some examples, the network node is the AP.

In some examples, the respective set of workload parameters of each AI workload of the set of multiple AI workloads includes one or more of a priority of that AI workload; an inference latency constraint of that AI workload; a quantity of compute resources requested to execute that AI workload; or a type of processing unit requested to execute that AI workload.

In some examples, the compute resource availability at the AP is defined by one or more of a memory load usage at the AP; a memory bandwidth usage at the AP; a processor utilization at the AP; or a thermal constraint at the AP.

In some examples, the one or more criteria pertaining to the set of network parameters include one or more of a threshold packet rate; a threshold quality of service level; a threshold packet delay; or a threshold amount of buffered network traffic.

FIG. 11 shows a flowchart illustrating an example process 1100 performable by or at a network node that supports compute resource orchestration framework for balancing AI workloads and network performance. The operations of the process 1100 may be implemented by a network node or its components. For example, the process 1100 may be performed by a wireless communication device, such as the wireless communication device 1000 described with reference to FIG. 10, operating as or within a wireless AP or a wireless STA. In some examples, the process 1100 may be performed by a wireless AP or a wireless STA, such as one of the APs 102 or the STAs 104 described with reference to FIG. 1.

In some examples, in 1105, the network node may receive a set of multiple workload requests corresponding to a set of multiple AI workloads of an AP, the set of multiple AI workloads having a set of multiple sets of workload parameters, and each AI workload of the set of multiple AI workloads having a respective set of workload parameters of the set of multiple sets of workload parameters. The operations of 1105 may be performed in accordance with examples as disclosed herein. In some implementations, aspects of the operations of 1105 may be performed by an AI workload request component 1025 as described with reference to FIG. 10.

In some examples, in 1110, the network node may assign compute resources to the set of multiple AI workloads in accordance with the set of multiple sets of workload parameters of the set of multiple AI workloads; a compute resource availability at the AP; and one or more criteria pertaining to a set of network parameters, the set of network parameters including one or more of a packet rate, a QoS level, a packet delay, or an amount of buffered network traffic in a wireless network in which the AP operates. The operations of 1110 may be performed in accordance with examples as disclosed herein. In some implementations, aspects of the operations of 1110 may be performed by an AI workload assignment component 1035 as described with reference to FIG. 10.

Implementation examples are described in the following numbered clauses:

Clause 1: A method for compute resource orchestration at a network node, including: receiving a plurality of workload requests corresponding to a plurality of AI workloads of an AP, the plurality of AI workloads having a plurality of sets of workload parameters, and each AI workload of the plurality of AI workloads having a respective set of workload parameters of the plurality of sets of workload parameters; and assigning compute resources to the plurality of AI workloads in accordance with: the plurality of sets of workload parameters of the plurality of AI workloads; a compute resource availability at the AP; and one or more criteria pertaining to a set of network parameters, the set of network parameters including one or more of a packet rate, a QoS level, a packet delay, or an amount of buffered network traffic in a wireless network in which the AP operates.

Clause 2: The method of clause 1, further including: receiving an indication of the set of network parameters.

Clause 3: The method of clause 1, where the network node assigns the compute resources to the plurality of AI workloads in accordance with a workload assignment scheme that accounts for the respective set of workload parameters of each AI workload of the plurality of AI workloads and for the compute resource availability at the AP, and satisfies the one or more criteria pertaining to the set of network parameters.

Clause 4: The method of clause 3, where the set of network parameters includes a packet rate, and satisfying the one or more criteria pertaining to the set of network parameters includes the packet rate satisfying a threshold packet rate.

Clause 5: The method of any of clauses 1-4, further including: scheduling a time domain order of an execution of the plurality of AI workloads in accordance with the plurality of sets of workload parameters of the plurality of AI workloads, with the compute resource availability at the AP, and with the one or more criteria pertaining to the set of network parameters.

Clause 6: The method of clause 5, where scheduling the time domain order includes: determining whether a dequeue counter of a workload queue satisfies a threshold; and sorting a plurality of dequeued workloads by execution time, where the time domain order is in accordance with sorting the plurality of dequeued workloads.

Clause 7: The method of clause 5, where the time domain order of the execution of the plurality of AI workloads is in accordance with a plurality of workload queues, and where the method further includes: scheduling the plurality of AI workloads in the plurality of workload queues in accordance with a respective priority of each AI workload of the plurality of AI workloads, and the AP being unable to simultaneously execute the plurality of AI workloads in accordance with the compute resource availability at the AP or the one or more criteria pertaining to the set of network parameters.

Clause 8: The method of clause 7, where scheduling the plurality of artificial intelligence workloads includes: determining whether a dequeue counter of a first queue of the plurality of workload queues satisfies a threshold; and executing a workload from a second queue of the plurality of workload queues in accordance with the dequeue counter satisfying the threshold, where the first queue comprises higher priority workloads than the second queue.

Clause 9: The method of any of clauses 5-8, further including: loading a plurality of AI models to at least one memory in accordance with the time domain order of the execution of the plurality of AI workloads, where each AI workload of the plurality of AI workloads is executed using a respective AI model of the plurality of AI models.

Clause 10: The method of clause 9, further including: offloading one or more AI models of the plurality of AI models from the at least one memory in accordance with one or more priorities of the one or more AI models being relatively lower than one or more other priorities of one or more other AI models of the plurality of AI models.

Clause 11: The method of any of clauses 1-10, where assigning the compute resources to the plurality of AI workloads includes: assigning a first set of compute resources of the AP to one or more first AI workloads of the plurality of AI workloads in accordance with the compute resource availability at the AP being able to execute the one or more first AI workloads and satisfy the one or more criteria pertaining to the set of network parameters; and assigning a second set of compute resources of the network node or another node to one or more second AI workloads of the plurality of AI workloads in accordance with the compute resource availability at the AP being unable to additionally execute the one or more second AI workloads and satisfy the one or more criteria pertaining to the set of network parameters.

Clause 12: The method of any of clauses 1-11, further including: assigning a first portion of a set of cache resources to a set of networking workloads of the AP to satisfy the one or more criteria pertaining to the set of network parameters; and assigning a second portion of the set of cache resources to the plurality of AI workloads in accordance with the plurality of sets of workload parameters of the plurality of AI workloads.

Clause 13: The method of any of clauses 1-12, further including: adjusting a threshold network parameter in accordance with receiving the plurality of workload requests corresponding to the plurality of AI workloads, where the one or more criteria pertaining to the set of network parameters include the threshold network parameter.

Clause 14: The method of clause 13, where the network node adjusts the threshold network parameter in a first direction to prioritize the packet traffic in the wireless network for which the AP manages over the plurality of AI workloads, or a second direction to prioritize one or more of the plurality of AI workloads over the packet traffic in the wireless network for which the AP manages.

Clause 15: The method of any of clauses 1-14, where the compute resources assigned to the plurality of AI workloads are of the AP, the network node, one or more other network nodes in the wireless network for which the AP manages, one or more cloud compute nodes, one or more edge compute nodes, or any combination thereof.

Clause 16: The method of any of clauses 1-15, where the network node is the AP.

Clause 17: The method of any of clauses 1-16, where the respective set of workload parameters of each AI workload of the plurality of AI workloads includes one or more of a priority of that AI workload; an inference latency constraint of that AI workload; a quantity of compute resources requested to execute that AI workload; or a type of processing unit requested to execute that AI workload.

Clause 18: The method of any of clauses 1-17, where the compute resource availability at the AP is defined by one or more of a memory load usage at the AP; a memory bandwidth usage at the AP; a processor utilization at the AP; or a thermal constraint at the AP.

Clause 19: The method of any of clauses 1-18, where the one or more criteria pertaining to the set of network parameters include one or more of a threshold packet rate; a threshold quality of service level; a threshold packet delay; or a threshold amount of buffered network traffic.

Clause 20: A network node for compute resource orchestration, including a processing system that includes processor circuitry and memory circuitry that stores code, the processing system configured to cause the network node to perform a method of any of clauses 1-19.

Clause 21: A network node for compute resource orchestration, including at least one means for performing a method of any of clauses 1-19.

Clause 22: A non-transitory computer-readable medium storing code for compute resource orchestration, the code including instructions executable by a processing system to perform a method of any of clauses 1-19.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information) or accessing (such as accessing data stored in memory), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination may be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A network node, comprising:
a processing system that comprises processor circuitry and memory circuitry that sores code, the processing system configured to cause the network node to:
receive a plurality of workload requests corresponding to a plurality of artificial intelligence workloads of an access point (AP), the plurality of artificial intelligence workloads having a plurality of sets of workload parameters, and each artificial intelligence workload of the plurality of artificial intelligence workloads has a respective set of workload parameters of the plurality of sets of workload parameters; and
assign compute resources to the plurality of artificial intelligence workloads in accordance with:
the plurality of sets of workload parameters of the plurality of artificial intelligence workloads,
a compute resource availability at the AP, and
one or more criteria pertaining to a set of network parameters, the set of network parameters comprising one or more of a packet rate, a quality of service (QoS) level, a packet delay, or an amount of buffered network traffic in a wireless network in which the AP operates.

2. The network node of claim 1, wherein the processing system is further configured to cause the network node to:
receive an indication of the set of network parameters.

3. The network node of claim 1, wherein the processing system is further configured to cause the network node to:
schedule a time domain order of an execution of the plurality of artificial intelligence workloads in accordance with the plurality of sets of workload parameters of the plurality of artificial intelligence workloads, with the compute resource availability at the AP, and with the one or more criteria pertaining to the set of network parameters.

4. The network node of claim 3, wherein, to schedule the time domain order, the processing system is further configured to cause the network node to:
determine whether a dequeue counter of a workload queue satisfies a threshold; and
sort a plurality of dequeued workloads by execution time, wherein the time domain order is in accordance with sorting the plurality of dequeued workloads.

5. The network node of claim 3, wherein the time domain order of the execution of the plurality of artificial intelligence workloads is in accordance with a plurality of workload queues, and the processing system is further configured to cause the network node to:
schedule the plurality of artificial intelligence workloads in the plurality of workload queues in accordance with a respective priority of each artificial intelligence workload of the plurality of artificial intelligence workloads, and the AP being unable to simultaneously execute the plurality of artificial intelligence workloads in accordance with the compute resource availability at the AP or the one or more criteria pertaining to the set of network parameters.

6. The network node of claim 5, wherein, to schedule the plurality of artificial intelligence workloads, the processing system is further configured to cause the network node to:
determine whether a dequeue counter of a first queue of the plurality of workload queues satisfies a threshold; and
execute a workload from a second queue of the plurality of workload queues in accordance with the dequeue counter satisfying the threshold, wherein the first queue comprises higher priority workloads than the second queue.

7. The network node of claim 3, wherein the processing system is further configured to cause the network node to:
load a plurality of artificial intelligence models to at least one memory in accordance with the time domain order of the execution of the plurality of artificial intelligence workloads, wherein each artificial intelligence workload of the plurality of artificial intelligence workloads is executed using a respective artificial intelligence model of the plurality of artificial intelligence models.

8. The network node of claim 7, wherein the processing system is further configured to cause the network node to:
offload one or more artificial intelligence models of the plurality of artificial intelligence models from the at least one memory in accordance with one or more priorities of the one or more artificial intelligence models being relatively lower than one or more other priorities of one or more other artificial intelligence models of the plurality of artificial intelligence models.

9. The network node of claim 1, wherein, to assign the compute resources to the plurality of artificial intelligence workloads, the processing system is configured to cause the network node to:
assign a first set of compute resources of the AP to one or more first artificial intelligence workloads of the plurality of artificial intelligence workloads in accordance with the compute resource availability at the AP being able to execute the one or more first artificial intelligence workloads and satisfy the one or more criteria pertaining to the set of network parameters; and
assign a second set of compute resources of the network node or another node to one or more second artificial intelligence workloads of the plurality of artificial intelligence workloads in accordance with the compute resource availability at the AP being unable to additionally execute the one or more second artificial intelligence workloads and satisfy the one or more criteria pertaining to the set of network parameters.

10. The network node of claim 1, wherein the processing system is further configured to cause the network node to:
assign a first portion of a set of cache resources to a set of networking workloads of the AP to satisfy the one or more criteria pertaining to the set of network parameters; and
assign a second portion of the set of cache resources to the plurality of artificial intelligence workloads in accordance with the plurality of sets of workload parameters of the plurality of artificial intelligence workloads.

11. The network node of claim 1, wherein the processing system is further configured to cause the network node to:
adjust a threshold network parameter in accordance with receiving the plurality of workload requests corresponding to the plurality of artificial intelligence workloads,
wherein the one or more criteria pertaining to the set of network parameters comprise the threshold network parameter.

12. The network node of claim 11, wherein the network node adjusts the threshold network parameter in:
a first direction to prioritize network traffic in the wireless network in which the AP operates over the plurality of artificial intelligence workloads, or
a second direction to prioritize one or more of the plurality of artificial intelligence workloads over the network traffic in the wireless network in which the AP operates.

13. The network node of claim 1, wherein the compute resources assigned to the plurality of artificial intelligence workloads are of the AP, the network node, one or more other network nodes in the wireless network in which the AP operates, one or more cloud compute nodes, one or more edge compute nodes, or any combination thereof.

14. The network node of claim 1, wherein the network node is the AP.

15. The network node of claim 1, wherein the respective set of workload parameters of each artificial intelligence workload of the plurality of artificial intelligence workloads comprises one or more of:
a priority of that artificial intelligence workload;
an inference latency constraint of that artificial intelligence workload;
a quantity of compute resources requested to execute that artificial intelligence workload; or
a type of processing unit requested to execute that artificial intelligence workload.

16. The network node of claim 1, wherein the compute resource availability at the AP is defined by one or more of:
a memory load usage at the AP;
a memory bandwidth usage at the AP;
a processor utilization at the AP; or
a thermal constraint at the AP.

17. The network node of claim 1, wherein the one or more criteria pertaining to the set of network parameters comprise one or more of:
a threshold packet rate;
a threshold QoS level;
a threshold packet delay; or
a threshold amount of buffered network traffic.

18. A method for compute resource orchestration at a network node, comprising:
receiving a plurality of workload requests corresponding to a plurality of artificial intelligence workloads of an access point (AP), the plurality of artificial intelligence workloads having a plurality of sets of workload parameters, and each artificial intelligence workload of the plurality of artificial intelligence workloads having a respective set of workload parameters of the plurality of sets of workload parameters; and
assigning compute resources to the plurality of artificial intelligence workloads in accordance with:
the plurality of sets of workload parameters of the plurality of artificial intelligence workloads,
a compute resource availability at the AP, and
one or more criteria pertaining to a set of network parameters, the set of network parameters comprising one or more of a packet rate, a quality of service (QoS) level, a packet delay, or an amount of buffered network traffic in a wireless network in which the AP operates.

19. The method of claim 18, further comprising:
receiving an indication of the set of network parameters.

20. The method of claim 18, further comprising:
scheduling a time domain order of an execution of the plurality of artificial intelligence workloads in accordance with the plurality of sets of workload parameters of the plurality of artificial intelligence workloads, with the compute resource availability at the AP, and with the one or more criteria pertaining to the set of network parameters.

21. The method of claim 20, wherein the time domain order of the execution of the plurality of artificial intelligence workloads is in accordance with a plurality of workload queues, and wherein the method further comprises scheduling the plurality of artificial intelligence workloads in the plurality of workload queues in accordance with:
a respective priority of each artificial intelligence workload of the plurality of artificial intelligence workloads, and
the AP being unable to simultaneously execute the plurality of artificial intelligence workloads in accordance with the compute resource availability at the AP or the one or more criteria pertaining to the set of network parameters.

22. The method of claim 20, further comprising:
loading a plurality of artificial intelligence models to at least one memory in accordance with the time domain order of the execution of the plurality of artificial intelligence workloads, wherein each artificial intelligence workload of the plurality of artificial intelligence workloads is executed using a respective artificial intelligence model of the plurality of artificial intelligence models.

23. The method of claim 22, wherein the network node offloads one or more artificial intelligence models of the plurality of artificial intelligence models from the at least one memory in accordance with one or more priorities of the one or more artificial intelligence models being relatively lower than one or more other priorities of one or more other artificial intelligence models of the plurality of artificial intelligence models.

24. The method of claim 18, wherein assigning the compute resources to the plurality of artificial intelligence workloads comprises:
assigning a first set of compute resources of the AP to one or more first artificial intelligence workloads of the plurality of artificial intelligence workloads in accordance with the compute resource availability at the AP being able to execute the one or more first artificial intelligence workloads and satisfy the one or more criteria pertaining to the set of network parameters; and
assigning a second set of compute resources of the network node or another node to one or more second artificial intelligence workloads of the plurality of artificial intelligence workloads in accordance with the compute resource availability at the AP being unable to additionally execute the one or more second artificial intelligence workloads and satisfy the one or more criteria pertaining to the set of network parameters.

25. The method of claim 18, further comprising:
assigning a first portion of a set of cache resources to a set of networking workloads of the AP to satisfy the one or more criteria pertaining to the set of network parameters; and
assigning a second portion of the set of cache resources to the plurality of artificial intelligence workloads in accordance with the plurality of sets of workload parameters of the plurality of artificial intelligence workloads.

26. The method of claim 18, further comprising:
adjusting a threshold network parameter in accordance with receiving the plurality of workload requests corresponding to the plurality of artificial intelligence workloads,
wherein the one or more criteria pertaining to the set of network parameters comprise the threshold network parameter.

27. The method of claim 26, wherein the network node adjusts the threshold network parameter in:
a first direction to prioritize network traffic in the wireless network in which the AP operates over the plurality of artificial intelligence workloads, or
a second direction to prioritize one or more of the plurality of artificial intelligence workloads over the network traffic in the wireless network in which the AP operates.

28. The method of claim 18, wherein the compute resources assigned to the plurality of artificial intelligence workloads are of the AP, the network node, one or more other network nodes in the wireless network in which the AP operates, one or more cloud compute nodes, one or more edge compute nodes, or any combination thereof.

29. The method of claim 18, wherein the network node is the AP.

30. The method of claim 18, wherein the respective set of workload parameters of each artificial intelligence workload of the plurality of artificial intelligence workloads comprises one or more of:
a priority of that artificial intelligence workload;
an inference latency constraint of that artificial intelligence workload;
a quantity of compute resources requested to execute that artificial intelligence workload; or
a type of processing unit requested to execute that artificial intelligence workload.
